(19) United States
(12) Patent Application Publication
(10) Pub. No.: US 2005/0081544 A1
(43) Pub. Date: Apr. 21, 2005

(54) Valve control method for refrigerator

(75) Inventor: Ki-Hong Jin, Busan City (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 10/960,076

(22) Filed: Oct. 8, 2004

(30) Foreign Application Priority Data
Oct. 21, 2003 (KR) 10-2003-0073552

(51) Int. Cl. G05D 23/32; F25B 5/00

(52) U.S. Cl. 62/199; 62/157

(57) ABSTRACT

The present invention relates to a valve control method for a refrigerator, and more particularly, to a valve control method for a refrigerator which controls a three-way valve for opening and closing refrigerant channels to a refrigerating chamber evaporator and a freshening chamber evaporator. The present invention is provided with the three-way valve of an AC valve for controlling the refrigerant to flow into the refrigerating chamber and the freshening chamber evaporator. In addition, in order to reduce driving noise generated from the three-way valve, the three-way valve is controlled to operate at a point of time when a predetermined time has passed after the compressor is driven. As a result, since driving noise caused from the three-way valve is drowned out by the driving noise of the three-way valve, an advantage of reducing the noise of the three-way valve can be expected.

### BACKGROUND OF THE INVENTION

1. Field of Invention

The present invention relates to a refrigerator, and more particularly, to a valve control method for a refrigerator which controls a three-way valve for controlling opening and closing refrigerant channels through which refrigerant flows into evaporators.

2. Description of the Prior Art

Hereinafter, a valve control method for a refrigerator according to a prior art will be described.

FIG. 1 is a block diagram of a cooling cycle for controlling temperatures in the refrigerator.

In order to control the temperatures in the refrigerator, the cooling cycle as shown in the figure is provided. A configuration for controlling the cooling cycle comprises a compressor 60 for compressing refrigerant, a condenser 10 for condensing the refrigerant, a refrigerating chamber evaporator 30 for evaporating the refrigerant in order to perform heat exchange in a refrigerating chamber, a freshening chamber evaporator 40 for evaporating the refrigerant in order to perform heat exchange in a freshening chamber, a freezing chamber evaporator 50 for evaporating the refrigerant in order to perform heat exchange in a freezing chamber; and a three-way valve 20 for controlling refrigerant channels through which the refrigerant flows into the refrigerating chamber evaporator or the freshening chamber evaporator.

A process that the three-way valve 20 controls the refrigerant channels to be opened and closed according to driving modes, temperatures and the like input from a control panel (not shown) is performed by means of the control of a microcontroller (not shown).

Upon review of the flow of the cooling cycle, the refrigerant is first compressed through the compressor 60. Then, the compressed refrigerant is delivered to the condenser 10. The flow of the refrigerant passing through the condenser 10 is controlled to the refrigerating chamber evaporator 30 or the freshening chamber evaporator 40 through the three-way valve 20.

If the three-way valve 20 opens the channel to the refrigerating chamber evaporator 30, the refrigerant is supplied to the refrigerating chamber evaporator 30. Accordingly, the refrigerating chamber evaporator 30 performs the heat exchange, and then, cool air is supplied to the refrigerating chamber by operating a fan (not shown) for the refrigerating chamber.

However, if the three-way valve 20 opens the channel to the freshening chamber evaporator 40, the refrigerant is supplied to the freshening chamber evaporator 40. Accordingly, the freshening chamber evaporator 40 performs the heat exchange, and then, cool air is supplied to the freshening chamber by operating a fan (not shown) for the freshening chamber.

In addition, the refrigerant flowing into the refrigerating chamber evaporator 30 and the freshening chamber evaporator 40 flows into the freezing chamber evaporator 50. The freezing chamber evaporator 50 performs the heat exchange, and then, cool air is supplied to the freezing chamber by operating a fan (not shown) for the freezing chamber.

The refrigerant passing through the freezing chamber evaporator flows into the compressor 60 again, and compressed. Then, the compressed refrigerant is delivered to the condenser 10, so that the above cooling cycle repeatedly operates.

Furthermore, if the channels are opened to both the refrigerating chamber and the freshening chamber evaporator by means of the operation of the three-way valve 20 and then the refrigerant flows into both the refrigerating chamber evaporator 30 and the freshening chamber evaporator 40, the heat exchanges are performed therein. Thus, the cool air can be supplied to both the refrigerating chamber and the freshening chamber simultaneously.

As reviewed in the cooling cycle, in order to supply the condensed refrigerant by passing through the condenser 10 to the refrigerating chamber and the freshening chamber evaporator, the three-way valve 20 operates, and thus, controls the flow directions of the refrigerant by controlling the refrigerant channels to be opened and closed.

At this time, as the three-way valve 20, an AC refrigerant valve and a DC refrigerant valve are mainly employed. The AC refrigerant valve is inexpensive but is noisy in its driving. However, the DC refrigerant valve is not noisy in its driving but is expensive.

The following example relates to a valve control method for a refrigerator when the AC refrigerant valve is employed as the three-way valve.

FIG. 2 is a view showing an operation for controlling the valve of the refrigerator according to the prior art. FIG. 3 is a flowchart illustrating a process of controlling the valve of the refrigerator according to the prior art.

As shown in the figures, with the cooling cycle of the prior art being embodied, the refrigerant passing through the condenser 10 is supplied to the refrigerating chamber evaporator 30 and the freshening chamber evaporator 40 by opening and closing refrigerant channels by means of the three-way valve. If a temperature in the freshening chamber is in unsatisfied condition, as shown in the figure, in order to supply the refrigerant to the freshening chamber evaporator 40, the three-way valve 20 is controlled so that the refrigerant channel to the freshening chamber evaporator 40 is opened. As a result, the refrigerant passing through the condenser 10 is delivered to the freshening chamber evaporator 40. Simultaneously, in order for the refrigerant not to flow into the refrigerating chamber evaporator 30, the three-way valve closes the refrigerant channel to the refrigerating chamber evaporator 30. Accordingly, the refrigerant passing through the condenser 10 does not flow into the refrigerating chamber evaporator 30. At this time, in a state where the refrigerant is supplied to the freshening chamber evaporator 40 but not supplied to the refrigerating chamber evaporator 30, as shown in FIG. 1, the compressor is not driven.

As described above, the refrigerant flows into only the freshening chamber evaporator 40 and then circulates in the cooling cycle. As a result, if the temperature in the refrigerating chamber is in unsatisfied condition although the temperature in the freshening chamber is in satisfied condition, the cooling cycle is controlled in order for the refrigerant to flow into the refrigerating chamber evaporator 30. To this end, the three-way valve 20 opens the refrigerant channel to the refrigerating chamber evaporator 30 that has been closed, while the refrigerant channel to the freshening chamber evaporator 40 that has been opened is closed. At this time, due to the operation of the three-way valve 20, a large driving noise occurs.

That is, when the temperature in the refrigerating chamber is in the unsatisfied condition, as shown in FIG. 1, in order to supply the refrigerant to the refrigerating chamber evaporator, the three-way valve 20 opens the refrigerant channel to the refrigerating chamber evaporator 30. As a result, the refrigerant passing through the condenser 10 is delivered to the refrigerating chamber evaporator 30. Simultaneously, in order for the refrigerant not to flow into the freshening chamber evaporator 40, the three-way valve 20 closes the refrigerant channel to the freshening chamber evaporator 40.

Therefore, the refrigerant passing through the condenser 10 does not flow into the freshening chamber evaporator 40. At this time, in a state where the refrigerant is supplied to the refrigerating chamber evaporator 30 and not supplied to the freshening chamber evaporator 40, as shown in FIG. 1, the compressor is driven.

That is, as shown in FIG. 2, in the prior art, the compressor is driven (step 100), and the three-way valve 20 controls the refrigerant channels immediately when the compressor starts to operate (step 110). That is, the refrigerant channels are switched to each other so that the refrigerant channel to the refrigerating chamber evaporator 30 is opened if the refrigerant channel to the freshening chamber evaporator 40 has been opened and the refrigerant channel to the freshening chamber evaporator 40 is opened if the refrigerant channel to the refrigerating chamber evaporator 30 has been opened.

However, when the three-way valve 20 opens and closes the refrigerant channels to the refrigerating chamber evaporator 30 and the freshening chamber evaporator 40, respectively, the three-way valve 20 switches the refrigerant channels to each other and simultaneously the compressor is driven. Accordingly, a driving noise of the compressor is added to the driving noise of the three-way valve 20, so that a user feels a large noise.

Whenever the three-way valve controls the refrigerant channels to be opened and closed as described above, there is a disadvantage in that the large noise occurs. As a result, in the prior art, the user feels unpleasant due to the driving noise caused from the refrigerant valve for controlling the refrigerant channels.

### SUMMARY OF THE INVENTION

Accordingly, an object of the present invention is to provide a valve control method for a refrigerator wherein a driving noise caused from a three-way valve for controlling refrigerant channels is controlled to be minimized.

According to an aspect of the present invention for achieving the objects, there is provided a valve control method for a refrigerator. The valve control method comprises: a compressor driving step of driving a compressor of a cooling cycle; and a refrigerant valve driving step of driving a three-way valve or an AC valve to control opening and closing refrigerant channels to a refrigerating chamber evaporator and a freshening chamber evaporator, if a predetermined time has passed after the compressor starts to operate.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a view showing a cooling cycle for controlling a temperature in a refrigerator;

FIG. 2 is a view showing an operation for controlling a valve of a refrigerator according to a prior art;

FIG. 3 is a flowchart illustrating a process of controlling the valve of the refrigerator according to the prior art;

FIG. 4 is a view showing an operation for controlling a valve of a refrigerator according to the present invention; and

FIG. 5 is a flowchart illustrating a process of controlling the valve of the refrigerator according to the present invention.

### DETAILED DESCRIPTION OF THE PREFERRED EMBODIMENT

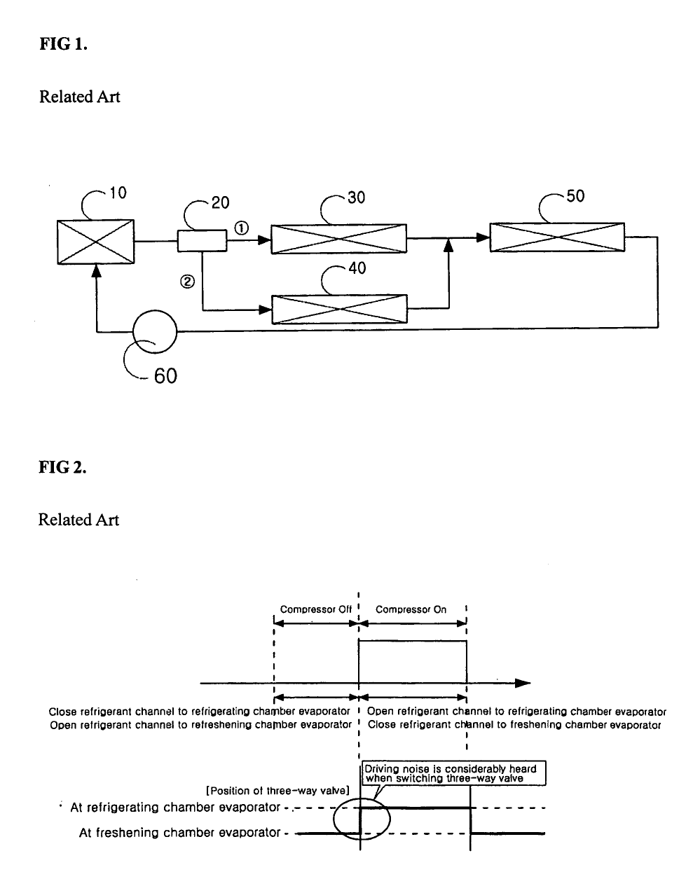

Hereinafter, a valve control method for a refrigerator according to the present invention will be described in detail with reference to FIG. 1.

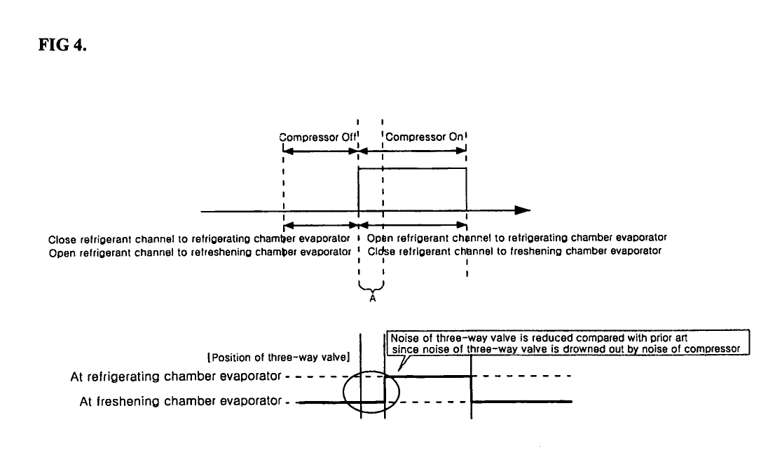

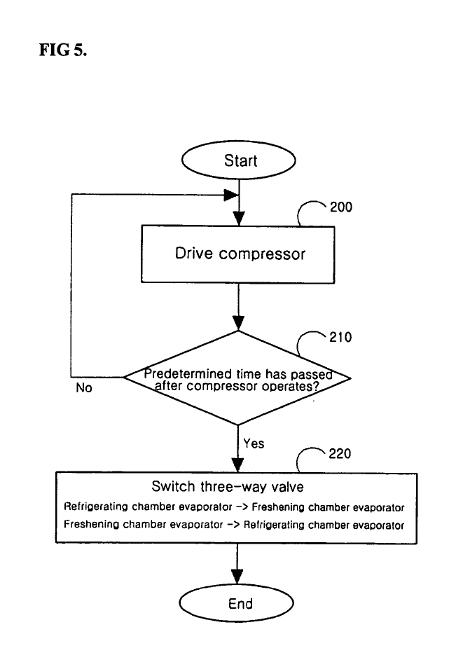

FIG. 4 is a view showing an operation for controlling a valve of the refrigerator according to the present invention. FIG. 5 is a flowchart illustrating a process of controlling the valve of the refrigerator according to the present invention.

As shown in the figures, with a cooling cycle embodied in the present invention, refrigerant compressed through a compressor 60 passes through a condenser 10. By controlling the refrigerant channels by means of a three-way valve 20, the refrigerant is supplied to a refrigerating chamber evaporator 30 and a freshening chamber evaporator 40.

When a temperature in a freshening chamber is in unsatisfied condition, as shown in the figure, in order to supply the refrigerant to the freshening chamber evaporator, the three-way valve 20 opens the refrigerant channel to the freshening chamber evaporator. As a result, the refrigerant passing through the condenser 10 is delivered to the freshening chamber evaporator 40.

Simultaneously, in order for the refrigerant not to flow into the refrigerating chamber evaporator 30, the three-way valve closes the refrigerant channel to the refrigerating chamber evaporator. Accordingly, the refrigerant passing through the condenser 10 does not flow into the refrigerating chamber evaporator 30. At this time, in a state where the refrigerant is supplied to the freshening chamber evaporator 40 but not supplied to the refrigerating chamber evaporator 30, as shown in FIG. 1, the compressor is not driven.

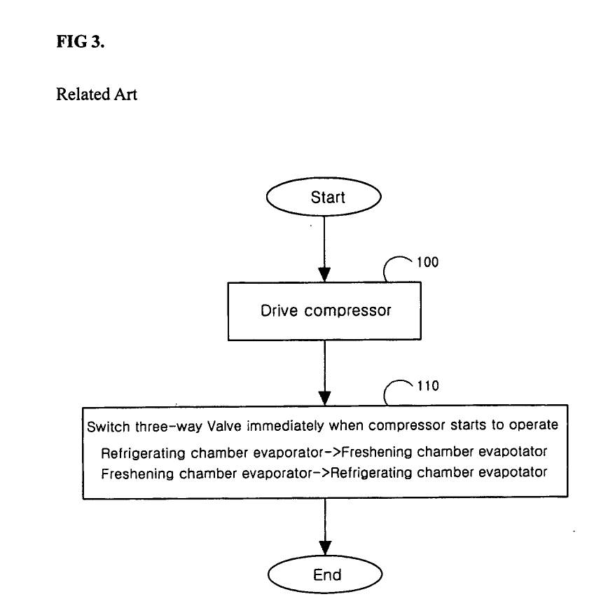

On the other hand, when a temperature in a refrigerating chamber is in unsatisfied condition, as shown in FIG. 3, in order to supply the refrigerant to the refrigerating chamber evaporator, the three-way valve 20 opens the refrigerant channel to the refrigerating chamber evaporator 30. As a result, the refrigerant passing through the condenser 10 is delivered to the refrigerating chamber evaporator 30.

At the same time, the three-way valve 20 closes the refrigerant channel to the freshening chamber evaporator 40 such that the refrigerant cannot flow into the freshening chamber evaporator 40. As a result, the refrigerant passing through the condenser 10 does not flow into the freshening chamber evaporator 40. At this time, in a state where the refrigerant is supplied to the refrigerating chamber evaporator 30 but not supplied to the freshening chamber evaporator 40, as shown in FIG. 3, the compressor is driven.

However, in the present invention, as shown in FIG. 3, the refrigerant channels of the three-way valve 20 are controlled at a point of time when a predetermined time (Time A) has passed after the compressor is driven. Accordingly, the driving noise of the three-way valve 20 is drowned out by the driving noise already generated from the compressor.

That is, in the present invention, the refrigerant channels are controlled by driving the three-way valve 20 at the predetermined delay time after the compressor starts to operate, as described above. Accordingly, since the driving noise generated from the three-way valve 20 is drowned out by the driving noise of the compressor, the level of noise which the user feels can be considerably reduced.

As shown in FIG. 5, according to the present invention, the compressor is first driven (step 200). Then, if the predetermined time has passed after the compressor is driven (step 210), the three-way valve 20 operates for controlling the refrigerant channels (step 220). That is, the refrigerant channels are controlled to be switched to each other so that the refrigerant channel to the refrigerating chamber evaporator 30 is opened if the refrigerant channel to the freshening chamber evaporator 40 has been opened and the refrigerant channel to the freshening chamber evaporator 40 is opened if the refrigerant channel to the refrigerating chamber evaporator 30 has been opened.

According to the valve control method for the refrigerator of the present invention so constructed, the following advantages can be expected. When driving the three-way valve for opening and closing the refrigerant channels for the refrigerant to flow into the refrigerating chamber evaporator and the freshening chamber evaporator, the present invention drives the three-way valve only while the compressor is being driven in order to reduce the driving noise of the three-way valve. Thus, in the present invention, the noise generated by using the three-way valve consisting of the AC valve is drowned out by the noise generated during the driving of the compressor, so that an advantage of reducing the level of noise that the user feels can be expected. In addition, since the three-way valve used in the present invention is the AC valve that is more inexpensive than a DC valve, the manufacturing costs of the refrigerator using the three-way valve can also be reduced.

As reviewed above, the present invention has the technical spirit in that the three-way valve is controlled and operates to control the flow of the refrigerant flowing into the respective evaporators at the point of time when the predetermined time has passed after the compressor is driven.

As described above, the present invention performs the switching operation of the AC refrigerant valve in order to open and close the refrigerant channels to the refrigerating chamber evaporator and the freshening chamber evaporator at the point of time when the predetermined time has passed after the compressor is driven. Accordingly, the driving noise of the AC refrigerant valve is drowned out by the driving noise of the compressor, so that the advantage of reducing the noise caused from the operation of the AC refrigerant valve can be expected.

The scope of the present invention is not limited to the embodiment described and illustrated above but is defined by the appended claim. It will be apparent that those skilled in the art can make various modifications and changes thereto within the scope of the invention defined by the claim. Therefore, the true scope of the present invention should be defined by the technical spirit of the appended claim.

1. A valve control method for a refrigerator, comprising:
a compressor driving step of driving a compressor of a cooling cycle; and
a refrigerant valve driving step of driving a three-way valve or an AC valve to control opening and closing refrigerant channels to a refrigerating chamber evaporator and a freshening chamber evaporator, if a predetermined time has passed after the compressor starts to operate.
